(19) United States
(12) Patent Application Publication
(10) Pub. No.: US 2022/0305523 A1
(43) Pub. Date: Sep. 29, 2022

(54) METHOD OF MASKING AND PRETREATING A PLASTIC PART PRIOR TO BEING SPRAY-PAINTED

(71) Applicant: Magna Exteriors Inc., Concord (CA)

(72) Inventor: Benjamin James BARBER, Rochester, MI (US)

(73) Assignee: Magna Exteriors Inc., Concord (CA)

(21) Appl. No.: 17/838,605

(22) Filed: Jun. 13, 2022

Related U.S. Application Data
(62) Division of application No. 16/957,540, filed on Jun. 24, 2020.
(60) Provisional application No. 62/615,090, filed on Jan. 9, 2018.

(51) Int. Cl. B05D 1/32; B05B 12/20; B05B 1/24; B05B 13/04; B05D 1/02; B05D 3/06; B60R 13/02; C09J 131/04

(52) U.S. Cl. CPC B05D 1/325; B05B 12/20; B05B 1/24; B05B 13/0452; B05D 1/02; B05D 3/067; B60R 13/02; C09J 131/04

(57) ABSTRACT

A method of masking and pretreating a plastic part prior to being spray-painted including the steps of providing a plastic part having one or more adhesive bond lines. The plastic part is typically an exterior automotive component having a painted show surface. Examples of plastic parts include but are not limited to lift gates, running boards, door trim pieces, spoilers, tail gates, front fascias and rear fascias. The method can also be used in connection with metal parts or any other application where a surface of the part will be painted and other surfaces on the part need to be protected from direct paint spray or paint overspray.

### CROSS-REFERENCE TO RELATED APPLICATIONS

This application is a divisional of U.S. patent application Ser. No. 16/957,540, filed Jun. 24, 2020, which is a National Stage of International Application No. PCT/US2019/012892, filed Jan. 9, 2019, and claims benefit of U.S. Provisional Application No. 62/615,090, filed Jan. 9, 2018. The disclosures of the above application are incorporated herein by reference.

### FIELD OF THE INVENTION

The present invention relates to the masking and pretreating of plastic parts or composite components to protect adhesive bond lines from contamination during further processes such as spray painting.

### BACKGROUND OF THE INVENTION

In the automotive field there has been an increased desire to form exterior panels out of plastic or composite materials. The plastic or composite materials provide automakers with the ability to create aesthetic shapes and contours that are otherwise not available using other materials such as metal. In particular composite vehicle lift gates are created by connecting together an outer panel and an inner panel. The inner panel provides the vehicle component with strength while the outer panel is painted to have a desired show surface. Creating plastic components in this manner requires forming the components individually, finishing the components by spraying them with paint and then adhesively bonding them together. The inner and outer panels typically have what is referred to as an adhesive bond line, which are surfaces on the outer panel and inner panel that meet and are connected together using bonding techniques such as using adhesives. Since the outer panel is typically spray-painted, the overspray from painting can land on the adhesive bond lines, thereby contaminating that area. Then when the outer panel is bonded to the inner panel the adhesive adheres to the paint overspray and creates a weak spot, which is undesirable and can cause the inner panel and outer panel to separate. These problems are also consistent with other vehicle component applications where plastic components are painted and then bonded together. Other examples include running boards, door trim components, spoilers, fascias and vehicle tailgates.

In order to address the contamination issue occurring at the adhesive bond lines paint masking tape has been applied to the areas to prevent overspray contamination. The use of masking tape is a time-consuming process and is also difficult to apply, particularly where the bond line curves or changes direction. In the area where the bond line curves or changes direction, specially cut strips of masking tape are used which have been die-cut to the desired shape. This creates additional waste when applying the masking tape to the part. It is therefore desirable to create a method of quickly applying a masking along the adhesive bond line on the part in a manner that will accommodate the shape of the adhesive bond line as well as cut down on the amount of time needed to apply the masking tape to the part prior to painting. It is also desirable to cut down on the amount of waste material created by using die-cut masking tape.

### SUMMARY OF THE INVENTION

The present invention is directed to a method of masking and pretreating a plastic part prior to being spray-painted. The method includes providing a plastic part formed of a composite material. In particular the part can be formed of thermoplastic olefin (TPO), acrylonitrile butadiene styrene (ABS) or other suitable materials. The plastic part has one or more adhesive bond lines which are defined as regions where the plastic part is adhesively bonded with other components during assembly. In addition to providing the plastic part the method includes providing a robotic arm that has an applicator capable of applying a liquid mask to the one or more bond lines on the plastic part. Also connected to the robotic arm is an ultraviolet light source. For holding the plastic part there is a holder that has a work surface for securely holding the plastic part relative to the robotic arm. The holder includes clamps that assist in holding the plastic part.

The method begins by placing the plastic part onto the holder in securing the plastic part with clamps that are part of the holder. Next a step of moving the robotic arm toward the holder and into position near the one or more bond lines. Then the robotic arm performs a first pass by moving the robotic arm and applying a liquid mask from the applicator to the one or more bond lines, while moving the robotic arm along a complete surface of the one or more bond lines. Then the method involves stopping the flow of liquid mask from the applicator once the one or more bond lines have been covered with the liquid mask. Next a step of curing occurs where the liquid mask is cured by moving the ultraviolet light source to a predetermined distance from the liquid mask. Then activating the ultraviolet light source on the robotic arm and performing a second pass of the robotic arm by moving the ultraviolet light source along the complete surface of the one or more bond lines, then turning off the ultraviolet light source upon completing the second pass. The next step involves moving the robotic arm away from the holder and removing the plastic part, which now has a cured mask on the one or more bond lines so that the plastic part can be painted without worry of having one or more bond lines contaminated with paint overspray.

### BRIEF DESCRIPTION OF THE DRAWINGS

The present invention will become more fully understood from the detailed description and the accompanying drawings, wherein:

FIG. 1 is an exploded side view of a liftgate inner panel and outer panel.

FIG. 2 is a side environmental view of a liftgate outer panel connected to a holder with a robotic arm applying a liquid mask during a first pass.

FIG. 3 is a side environmental view of a liftgate outer panel connected to a holder with a robotic arm curing the liquid mask during a second pass.

FIG. 4 is a side environmental perspective view of the cured mask being removed after having been painted.

### DETAILED DESCRIPTION OF THE PREFERRED EMBODIMENTS

The following description of the preferred embodiment is merely exemplary in nature and is in no way intended to limit the invention, its application, or uses.

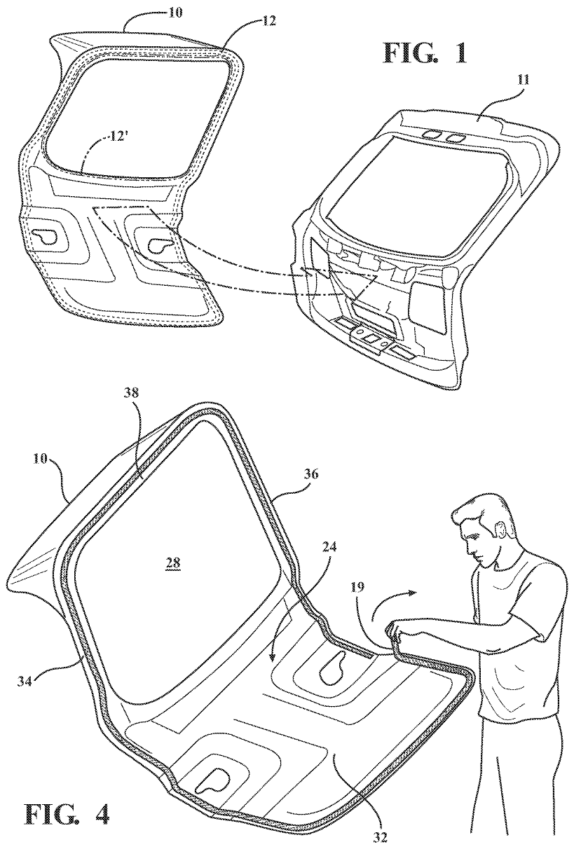

FIG. 1 shows an exploded side perspective view of two exemplary plastic parts that are an outer panel 10 and inner panel 11 of a liftgate, which will also be referred to as plastic parts since a liftgate is just one possible application of this invention, and it is within the scope of this invention for other plastic parts to also benefit from the liquid masking method described herein. The plastic part is typically an exterior automotive component having a painted show surface. Typically the plastic part is formed by injection molding TPO or in some cases ABS, however, it is possible for other materials to be used as well as other forming processes such as compression molding, thermoforming, vacuum forming, etc. Examples of plastic parts include but are not limited to lift gates, running boards, door trim pieces, spoilers, tail gates, front fascias and rear fascias. The method can also be used in connection with metal parts or any other application where a surface of the part will be painted and other surfaces on the part need to be protected from direct paint spray or paint overspray. The outer panel 10 and the inner panel 11 are bonded together using adhesives, along a bond line 12 shown on the inside surface of outer panel 10. There is also a corresponding bond line on the inner panel 11 that is not illustrated but it is within the scope of this invention for the liquid mask to be applied to the inner panel 11 as well in embodiments where the bond line on the inner panel is also subject to contamination. Additionally a second bond line 12′ is provided as an alternative embodiment where a window (not shown) is able to be bonded to the outer panel 10. A similar bond line can also be provided and masked by a liquid mask on the inner panel.

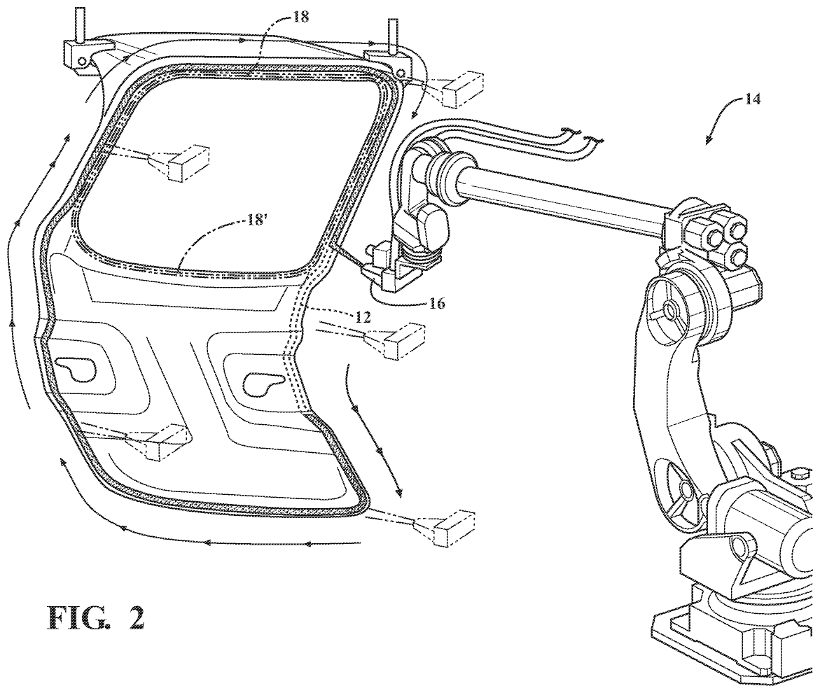

The outer panel 10 is painted prior to being bonded to the inner panel 11. During the painting process it is important to protect the bond line 12, 12′ shown in an inside surface of the outer panel 10, from being contaminated by paint overspray. Protecting the bond line 12, 12′ is accomplished by practicing the method of masking and pretreating the plastic part prior to being spray painted and then removing the making after painting, which will is shown in FIGS. 2-4, which will now be described.

Referring now to FIGS. 2-4, the inside surface of the outer panel 10 positioned on a holder 20. The holder 20 includes clamps 22 that are used to hold the outer panel 10 onto the holder 20. The clamps 22 can also be contoured surfaces or other features that ensure consistent placement of the outer panel 10 on the holder 20. The outer panel 10 has is formed of composite material such as thermoplastic olefin (TPO) or acrylonitrile butadiene styrene (ABS) used to form a body 24 of the outer panel 10. The inner panel 11 is also composite material formed of similar materials. The body 24 has a body perimeter 26, which defines the outside edges of the outer panel. The body 24 also has a window aperture 28 that is defined by a window aperture perimeter 30. The window aperture perimeter 30 has a lower boundary formed by a lower portion 32 of the body 24, two side boundaries formed by side pillars 34, 36 of the body 24 and a top boundary formed by a top portion 28 of the body 24. A bond line 12 that circumscribes the body 24 near the body perimeter 26. There is also a bond line 12′ that circumscribes the body 24 near the window aperture perimeter 30. The bond line 12′ is an optional or alternative bond line that is used in embodiments of the invention where a window glass is adhesively bonded to the bond line 12′. The bond line 12, 12′ is the area that will be masked with the liquid masking prior to applying painting the outer surface of the plastic part.

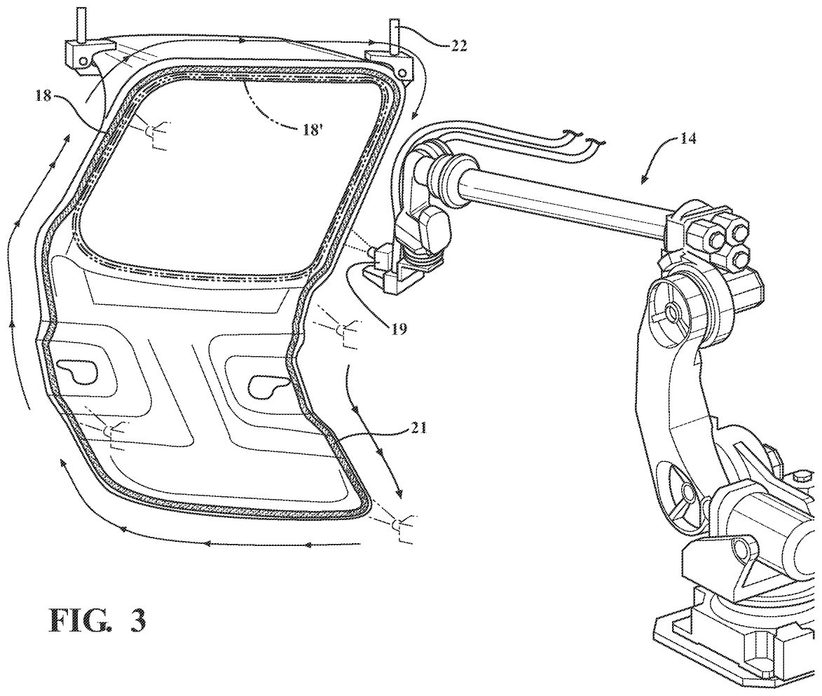

As shown in FIGS. 2-3 there is a robotic arm 14 has moved into position and has an applicator 16 tip that will dispense the liquid masking 18, 18′ onto the respective bond line 12, 12′. The applicator 16 in a preferred embodiment of the invention is hydraulic but it is within the scope of this invention for the applicator to also be a pneumatic sprayer, roller or brush depending on the application. The robotic arm 14 will move around the entire periphery of the liftgate outer panel and apply a layer of liquid masking to the entire adhesive bond line 12, 12′ in what is referred to as a first pass. In a preferred embodiment of the invention the liquid mask material is an ultraviolet light curable acrylate that is heated to a temperature of about 107 degrees Fahrenheit prior to applying the liquid mask 18, 18′ from the applicator 16. The liquid mask 18, 18′ has a material viscosity of less than or equal to 15,000 centipoise (cP) and is pressured to at least 200 psi in order to achieve the desired flow through the applicator 16. However it is within the scope of this invention for different viscosities and pressures to be used depending on the variables of the application.

The robotic arm 14 also has an ultraviolet light source 15 mounted thereon that is used to cure the liquid mask 18, 18′ into a cured mask 21 (shown in FIG. 4) during what is referred to as a second pass of the robotic arm 14. While an ultraviolet light source 15 is shown and described as being on the same robotic arm 14 as the applicator is within the scope of this invention for the ultraviolet light source 15 to be connected to a second robotic arm be a stationary ultraviolet light source where the plastic part is moved under it depending on the needs to a particular application. The cured mask 21 removably adheres to the surface of the bond line 12, 12′ with enough adherence to resist washing and paint spraying processes, but can then be uniformly pulled off manually, as shown in FIG. 4 without leaving any residue. The cured mask 21 also is not affected by ambient temperature and humidity, which allows the plastic part to be stored in a location that does not have any temperature or humidity control without any concern for the cured mask 21 peeling off the plastic part. The ultraviolet light source is a light that has a peak wavelength of 395 nm and is ideally positioned at a distance of less than or equal to 25 mm from the liquid mask 18, 18′ during the second pass of the robotic arm 14. Also during the second pass, the robotic arm 14 moves the ultraviolet light source 15 at a speed that is one range selected from the group including about 3 cm/sec to about 11 cm/sec, about 5 cm/sec to about 7 cm/sec, about 9 cm/sec to about 11 cm/sec. The speed depends on the thickness of the liquid mask 18, 18′, area and type of material used.

The method of masking and pretreating the plastic part prior to being spray painted as shown in FIGS. 2-3 is summarized as the follows. A step of providing a plastic part having one or more bond lines 18, 18′. A step of providing a robotic arm 14 having an applicator 16 capable for applying a liquid mask 18, 18′ onto the one or more bond lines 12, 12″. A step providing an ultraviolet light source 15 connected to the robotic arm 14. A step of providing a holder 20 for securely holding the plastic part relative to the robotic arm 14 and placing the plastic part onto the holder 20. A step of moving the robotic arm 14 toward the holder 20 into position near the one or more bond lines 12, 12′ and performing a first pass of the robotic arm 14 by moving the robotic arm 14 and applying the liquid mask 18, 18′ from the applicator 16 to the one or more bond lines 12, 12′ while moving the robotic arm 14 along a complete surface of the one or more bond lines 12, 12′ and stopping flow of the liquid mask 18, 18′ from the applicator 16 once the one or more bond lines 12, 12′ has been covered with liquid mask 18, 18′. Next a step of curing the liquid mask 18, 18′ occurs by moving the ultraviolet light source 15 to a predetermined distance from the liquid mask 18, 18′, then activating the ultraviolet light source 15 on the robotic arm 14 and performing a second pass of the robotic arm 14 by moving the ultraviolet light source 15 along the complete surface of the one or more bond lines 12, 12′ and turning off the ultraviolet light source upon completing the second pass, thereby forming a cured mask 21. Then the step of moving the robotic arm 14 away from the holder 20 and removing the plastic part. Next the step of spray painting or treading the plastic par occurs and then the cured mask 21 is removed exposing the uncontaminated bond line 12, 12′ to the plastic part can then be bonded to other components. In an alternate embodiment of the invention a different liquid mask material is used along with a heat cured method. The liquid mask material is a poly vinyl acetate (PVA) dispersed in an aqueous solution. It is also within the scope of this invention for the PVA to be dispersed in an organic solution depending on a particular application. Examples of PVAs include Groco 2220 or Groco 2223 produced by Groco Specialty Coatings Company of Dallas Tex. Another exemplary material is Kollicoate SR 30 D produced by BASF North America Inc. In addition to using PVA it is also within the scope of this invention to use liquid vinyl-acetate-acrylic copolymer (VAA) dispersed in an aqueous solution. It is also within the scope of this invention for the VAA to be dispersed in an organic solution depending on a particular application. The PVA or VAA is optionally mixed with thickening agents to achieve a desired viscosity ranging from 7000 centipoise to 29,000 centipoise generally, 13,000 centipoise to 18,000 centipoise specifically and about 15,000 centipoise ideally. An example of a suitable thickening agent, includes but is not limited to poly(ethylene oxide). The liquid PCA or VAA material is applied using an applicator on the tip of the robotic arm. The applicator can be a pneumatic sprayers, roller or brush depending on the application. In one particular application the applicator is dipped into a water bath between applications to prevent the liquid mask from curing and clogging the applicator.

The method of applying the liquid mask is the same as the first pass described above. However, instead of curing the liquid mask with an ultraviolet light source the liquid mask is cured using a heat source. After the liquid mask is applied, the plastic part is removed from the holder and the heat source is applied to the plastic part to cure the liquid mask. The heat source in one embodiment of the invention is an oven that heats the plastic part and liquid mask at a temperature of about 90° C. for ten minutes. However it is within the scope of the invention for different temperatures to be used and different time durations to be used depending on the size of the part, thickness and composition of the liquid mask. It is also within the scope of this invention for the part to stay on the holder and be cured using infrared lights. The end result is that the one or more adhesive bond lines on the plastic part are covered with a cured mask that will stay on until after the part has been painted. The cured mask can then be removed and the plastic part can be bonded along the adhesive bond lines without the presence of any contamination.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method of masking and pretreating a plastic part prior to being spray-painted comprising the steps of:
providing a plastic part having one or more bond lines;
providing a robotic arm having an applicator capable for applying a liquid mask on to the one or more bond lines;
providing an ultraviolet light source connected to the robotic arm;
providing a holder for securely holding the plastic part relative to the robotic arm;
placing the plastic part onto the holder;
moving the robotic arm toward the holder into position near the one or more bond lines and performing a first pass of the robotic arm by moving the robotic arm and applying the liquid mask from the applicator to the one or more bond lines while moving the robotic arm along a complete surface of the one or more bond lines and stopping flow of the liquid mask from the applicator once the one or more bond lines have been covered with liquid mask;
curing the liquid mask by moving the ultraviolet light source to a predetermined distance from the liquid mask, activating the ultraviolet light source on the robotic arm and performing a second pass of the robotic arm by moving the ultraviolet light source along the complete surface of the one or more bond lines and turning off the ultraviolet light source upon completing the second pass created a cured mask; and
moving the robotic arm away from the holder and removing the plastic part.

2. The method of claim 1 wherein during the step of curing the ultraviolet light source has a peak wavelength of 395 nm and is positioned at a distance of less than or equal to 25 mm from the liquid mask.

3. The method of claim 1 wherein during the step of curing the robotic arm moves the ultraviolet light source while performing the second pass at a speed in the range of about 3 cm/sec to about 11 cm/sec, wherein the speed selected depends on the type of liquid mask and thickness of the liquid mask so that the ultraviolet light passes over the liquid mask in a manner that there will be enough energization time in order to cure the liquid mask.

4. The method of claim 1 wherein the liquid mask is heated to a temperature of about 107 degree Fahrenheit prior to applying the liquid mask from the applicator.

5. The method of claim 1 wherein the liquid mask is an ultraviolet light curable acrylate.

6. The method of claim 1 further comprising the step of storing the removed plastic part in a location that does not have any temperature or humidity control.

7. The method of claim 1 wherein the plastic part is a liftgate panel.

8. The method of claim 1 wherein the liquid mask has a material viscosity less than or equal to 15,000 cP.

9. The method of claim 8 wherein the pressure of the liquid mask flowing through the applicator is at least 200 psi.

10. A method of masking and pretreating a plastic part prior to being spray-painted comprising the steps of:
providing a plastic part having one or more adhesive bond lines;
providing a robotic arm having an applicator capable for applying a liquid mask on to the one or more bond lines;
providing a holder with a work surface for securely holding the plastic part relative to the robotic arm;
providing a heat source for curing the liquid mask applied to the plastic part;
placing the plastic part onto the work surface of the holder;
moving the robotic arm to toward the holder into position near the one or more adhesive bond lines;
applying the liquid mask to the one or more bond lines while moving the robotic arm along a complete surface of the one or more bond lines;
moving the robotic arm away from the holder and removing the plastic part; and
applying the heat source to the plastic part to create a cured mask.

11. The method of claim 10 wherein the heat source is a heating oven where plastic part is placed.

12. The method of claim 10 wherein during the step of applying the liquid mask the robotic arm moves the applicator at a speed in the range of about 3 cm/sec to about 11 cm/sec, wherein the speed selected depends on the type of liquid mask and thickness of the liquid mask.

13. The method of claim 10 wherein the liquid mask is heated to a temperature of about 107 degree Fahrenheit prior to applying the liquid mask from the applicator.

14. The method of claim 10 wherein the liquid mask has a material viscosity less than or equal to 15,000 cP.

15. The method of claim 14 wherein the pressure of the liquid mask flowing through the applicator is at least 200 psi.

16. The method of claim 10 further comprising the step of storing the removed plastic part in a location that does not have any temperature or humidity control.

17. The method of claim 10 wherein the plastic part is a liftgate panel.

18. The method of claim 10 wherein the liquid mask is one selected from the group consisting essentially of a water based poly vinyl acetate, organic based polyvinyl acetate and a vinyl-acetate-acrylic copolymer dispersed in an aqueous solution.

19. The method of claim 18 wherein the liquid mask further includes poly(ethylene oxide).
